(19) United States
(12) Patent Application Publication
(10) Pub. No.: US 2006/0198402 A1
(43) Pub. Date: Sep. 7, 2006

(54) Energy stabilization of combined pulses from multiple lasers

(76) Inventors: Norman Hodgson, Belmont, CA (US); Luis A. Spinelli, Sunnyvale, CA (US)

Correspondence Address: STALLMAN & POLLOCK LLP, 353 SACRAMENTO STREET, SUITE 2200, SAN FRANCISCO, CA, 94111, US

(21) Appl. No.: 11/069,511

(22) Filed: Mar. 1, 2005

(51) Int. Cl. H01S 3/10

(52) U.S. Cl. 372/22; 372/21

(57) ABSTRACT

A combined radiation pulse of a predetermined energy is provided by temporally and spatially overlapping four pulses from four extra-cavity, frequency-tripled lasers. Frequency tripling is effected in each laser by a second-harmonic generating crystal followed by a third-harmonic generating crystal. One of the lasers includes a Pockels cell preceding the second-harmonic generating crystal. The third harmonic pulse from this laser is the fourth and last delivered in the sequence. The total available energy in three of the pulses is less than the predetermined energy. The cumulative integrated energy of the pulses is determined while the pulses are being delivered. When the energy is determined to have reached the predetermined value, the Pockels cell is activated to rotate the polarization plane of fundamental radiation entering the second-harmonic generating crystal, thereby terminating generation of the fourth pulse and delivering the combined radiation pulse at the predetermined energy.

### TECHNICAL FIELD OF THE INVENTION

The present relates to combining beams from a plurality of lasers. The invention relates in particular to combining pulses from a plurality of frequency-converted, diode-pumped lasers to provide a combined pulse, and controlling the energy of the combined pulse.

### DISCUSSION OF BACKGROUND ART

Pulsed, diode-pumped, solid-state (DPSS) lasers with high power output are increasingly being favored for industrial applications such as material processing, laser machining and the like. For some industrial applications, for example UV optical lithography, more power or more energy per pulse is required than a single DPSS laser can provide. A higher power or energy per pulse for such applications can be provided by combining pulses (beams) from two or more lasers.

One problem with combining pulses from a plurality of lasers is that inevitable pulse-to-pulse energy variation in the lasers makes control of the energy in a combined pulse by controlling the energy of pulses from individual lasers very difficult to implement. Problems of pulse-to-pulse repeatability can be particularly problematical in a pulsed DPSS laser when the fundamental laser output is converted in frequency, for example, frequency-doubled or frequency-tripled, using one or more optically nonlinear crystals. This is because any pulse-to-pulse instability of the fundamental output of the laser translates to a much higher instability of the second and higher harmonics. As frequency-converted lasers deliver lower power than fundamental counterparts thereof, it is frequency converted lasers that are most likely required in combination to provide power for a desired application.

There is a need for a method of controlling pulse-energy in a pulse formed by combining pulses from a plurality of frequency-converted DPSS lasers. Preferably the method should also be applicable to controlling pulse-energy in combined pulses from lasers that deliver only fundamental radiation.

### SUMMARY OF THE INVENTION

In one aspect, the present invention is directed to a method for terminating generation of frequency-converted output in a frequency-converted laser wherein at least one optically nonlinear crystal is arranged to generate the frequency-converted output from radiation plane-polarized in a predetermined polarization plane. The method comprises rotating the polarization plane of the plane-polarized radiation entering the optically nonlinear crystal.

In one preferred implementation of the method, the frequency-converted output radiation is third-harmonic (3H) radiation generated by generating second harmonic (2H) radiation from the fundamental in one optically nonlinear crystal and generating the 3H-radiation in another optically nonlinear crystal by mixing the 2H radiation with fundamental radiation. To effect the termination of 3H radiation generation, the polarization plane of the fundamental radiation is rotated by a Pockels cell before the fundamental radiation can interact with the 2H-radiation generating crystal.

In another aspect the present invention is directed to a method of delivering an amount of laser radiation having a predetermined energy to a laser beam combiner. The method comprises delivering a plurality N-1 of laser pulses from a corresponding plurality of N lasers to the beam combiner. The cumulative energy delivered by the N-1 laser pulses is determined. If the cumulative energy is determined to be less than the predetermined energy, an N^{th} laser delivers a portion of an N^{th} pulse, the portion having an energy sufficient such that the total energy delivered is about equal to the predetermined energy. Other aspects and embodiments of the present invention will be evident from the detailed description provided hereinbelow.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 schematically illustrates a preferred embodiment of apparatus in accordance with the present invention including four DPSS frequency-tripled pulsed lasers each thereof including two optically nonlinear crystals and having pulses thereof delivered to a beam combiner to provide a combined pulse, and wherein the energy of the combined pulse is controlled by measuring the cumulative energy in all of the frequency-tripled pulses and, from the measurement, controlling the energy of a frequency-tripled pulse from a single one of the lasers using a Pockels cell in combination with one of the optically nonlinear crystals.

FIG. 2 is a graph schematically depicting computed pulse power as a function of time for a combined pulse formed from one sequence of four simulated pulses delivered by the apparatus of FIG. 1, with three thereof nearly simultaneously delivered and a fourth pulse having controllable energy delivered after a predetermined delay time.

FIG. 2A is a graph schematically depicting computed pulse power as a function of time for a combined pulse formed from one sequence of four simulated pulses delivered by the apparatus of FIG. 1, with three thereof nearly simultaneously delivered and a fourth pulse having controllable energy delivered after a predetermined delay time selected such that all of the energy in the three near simultaneous pulses has been delivered before initiation of delivery of the fourth pulse.

FIG. 3 is a graph schematically depicting computed cumulative energy as a function of time for the sequence of pulses of FIG. 2 together with the contribution to the cumulative energy of the fourth pulse.

FIG. 3A is a graph schematically depicting computed cumulative energy as a function of time for the sequence of pulses of FIG. 2A together with the contribution to the cumulative energy of the fourth pulse.

FIG. 4 is a graph schematically depicting computed pulse power as a function of time for a combined pulse formed from another sequence of four simulated pulses delivered by the apparatus of FIG. 1, with temporal spacing between pulses selected to reduce build up of power in the combined pulse and with the fourth pulse having controllable energy and delivered a predetermined delay time following delivery of the third pulse.

FIG. 5 is a graph schematically depicting computed cumulative energy as a function of time for the sequence of pulses of FIG. 4 together with the contribution to the cumulative energy of the third and fourth pulses.

FIG. 6 schematically illustrates another preferred embodiment of apparatus in accordance with the present invention similar to the apparatus of FIG. 1, but wherein the energy of the combined pulse is controlled by controlling the energy of a frequency-tripled pulse from a single one of the lasers using a Pockels cell in combination with a polarization selective reflector and wherein the controlling laser further includes an optical delay line between a point at which the cumulative energy is measured and the Pockels cell.

### DETAILED DESCRIPTION OF THE INVENTION

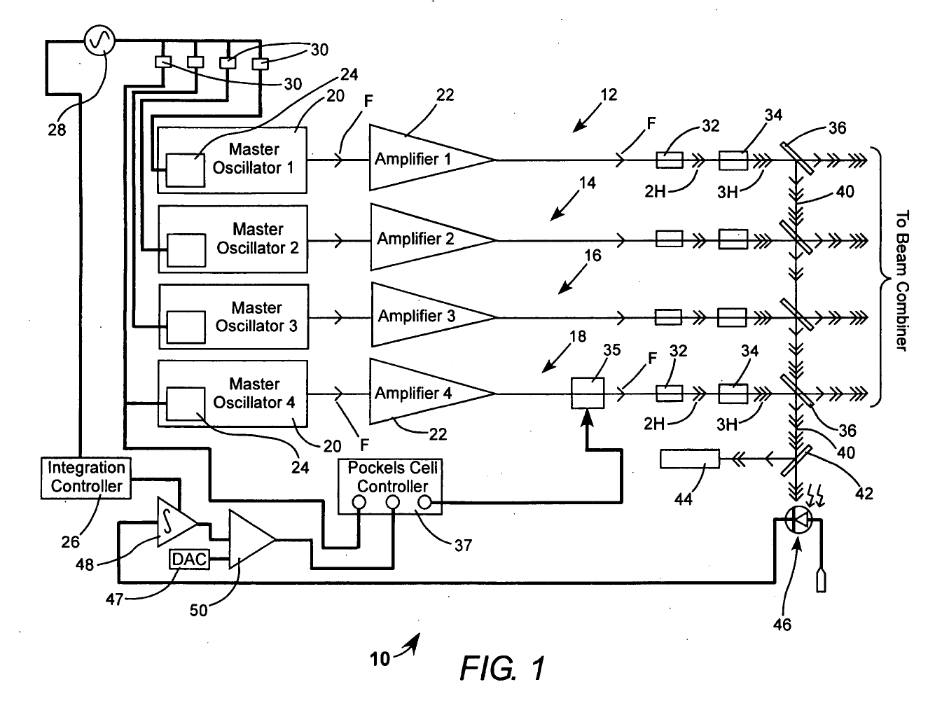

Referring now to the drawings, wherein like components are designated by like reference numerals, FIG. 1 schematically illustrates one preferred embodiment 10 of multiple pulsed-laser apparatus in accordance with the present invention. Apparatus 10 includes four lasers 12, 14, 16, and 18, each thereof including a master oscillator 20 and a power amplifier 22. In one example of the inventive apparatus, each master oscillator is a diode-pumped neodymium-doped YAG (Nd:YAG) laser emitting fundamental radiation (designated in FIG. 1 by a single open arrowhead F) having a wavelength of 1064 nm. Each power amplifier is also diode-pumped and has a Nd:YAG gain medium. Neodymium-doped yttrium vanadate (Nd:YVO4) is another gain-medium that can be used to generate fundamental radiation having a wavelength of about 1064 nm. Neodymium-doped yttrium lithium fluoride (Nd:YLF) can be used to generate fundamental radiation having a wavelength of about 1047 nm or about 1053 nm. Neodymium-doped yttrium aluminum oxide (Nd:YALO) can be used to generate fundamental radiation having a wavelength of about 1079 nm. Each of the Nd:YAG lasers exemplified here delivers pulses having a duration of about 150 nanoseconds (ns) at a pulse-repetition frequency (PRF) of up to about 50 kilohertz (KHz).

Each laser includes a Q-switch 24 for providing pulsed operation of the laser. The Q-switches are controlled by an integration controller 26 via a master clock 28 and four individual delay units 30, one delay unit for each Q-switch. Master clock 28 determines the pulse repetition frequency (PRF) of the lasers (which is preferably precisely matched) and the delay units are adjusted to synchronize pulses from each laser such that there is a desired temporal overlap between the pulses, allowing the pulses to be combined and summed after being frequency converted.

Fundamental output (pulses) F from each laser are converted to second-harmonic radiation (pulses) by an optically nonlinear crystal 32. The second-harmonic (2H) radiation and the direction of propagation thereof are designated in FIG. 1 by double open arrowheads. The 2H radiation (pulses) and residual (unconverted) fundamental radiation from each optically nonlinear crystal 32 are combined in an optically nonlinear crystal 34 to provide third-harmonic radiation (pulses). The third-harmonic (3H) radiation and the direction of propagation thereof are designated in FIG. 1 by triple open arrowheads. In this example 2H-pulses have a wavelength of about 532 nm. The 3H-pulses have a wavelength of about 355 nm, i.e., the 3H-pulses are pulses of UV radiation.

Laser 18 includes a Pockels cell 35 controlled by a controller 37. Pockels cell 35 is an electro-optic device that can rotate the polarization plane of radiation passing therethrough to an extent dependent on an electrical potential applied thereto by controller 37. In a normal state, the polarization of radiation transmitted by the Pockels cell is that which is required for optically nonlinear crystal 32 to effect second harmonic generation, such that crystal 34 can effect the required 3H frequency conversion.

The 3H-pulses from each optically nonlinear crystal 34, together with any residual fundamental and 2H radiation are incident on a beamsplitters or sampling mirrors 36. Each beamsplitter reflects a small sample fraction, for example, about 0.1% or less of the radiation incident thereon. The reflected fractions follow a common path 40 and are representative of the energy in the transmitted portions of the pulses. The transmitted portions of the pulses are delivered to a beam combiner for forming a single pulse. Residual fundamental and 2H content in the transmitted pulses can be removed by a dichroic filter or filters, preferably before the pulses are combined. Several beam combining methods are well-known in the art, and a detailed description of any one of these methods is not necessary for understanding principles of the present invention. Accordingly, such a detailed description is not presented herein.

In one example of operation of apparatus 10, delays 30 are adjusted such that 3H pulses delivered by the 4 lasers 12, 14, and 16, are delivered essentially simultaneously and a pulse from laser 18 is delivered after a delay time t_{D} such that, when spatially overlapped in a beam combiner, the pulses form a continuous pulse having a peak power about three times that of any of the individual pulses, but having a longer duration than the individual pulses, dependent primarily on the delay time t_{D}.

The samples along path 40 are intercepted by a dichroic beamsplitter 42. Beamsplitter 42 reflects the 2H and fundamental content of the samples to a beam dump 44. The 3H content of the samples is incident on a UV sensitive photodiode 46. Such a photodiode has a response time of about 100 picoseconds which is very much less than the duration of pulses delivered by the lasers in this example.

The output of photodiode 46 is integrated by an integrator 48 effectively summing the energy in all of the samples. The output of the integrator is constantly compared with a value supplied by a digital-to-analog converter (DAC) 47 and representative of a desired total energy in a summed pulse. At some time during the delivery of the pulse from laser 18, the integrator output matches the total energy signal, the comparator output triggers Pockels cell controller 37, and the controller delivers an electrical potential to the Pockels cell 35 that rotates the plane of fundamental radiation transmitted thereby to an orientation in which crystal 34 can not generate 2H-radiation, preferably through 90°. With the polarization thus rotated, laser 18 can also no longer deliver 3H-radiation. Accordingly delivery of 3H-energy in the pulse being delivered is terminated, and laser 18 no longer contributes to the combined 3H-pulse formed by the combiner. Provided that the Pockels cell is triggered after all or most of the energy in the third pulse in an overlapping sequence thereof is delivered, terminating the fourth pulse as thus described controls the energy in the combined pulse at about the desired value.

It should be noted here that the Pockels cell could be placed between optically nonlinear crystal 32 and 34 and the pulse terminating method would still function. In any sequence of optically nonlinear crystals for converting frequency to a third or higher harmonic, each crystal must receive one, two or more radiation frequencies in a particular polarization orientation to the crystal and (if there is more than one frequency) to each other. If the polarization plane of one or more of the radiation frequencies is rotated before the first crystal, or between crystals, the desired frequency conversion will cease.

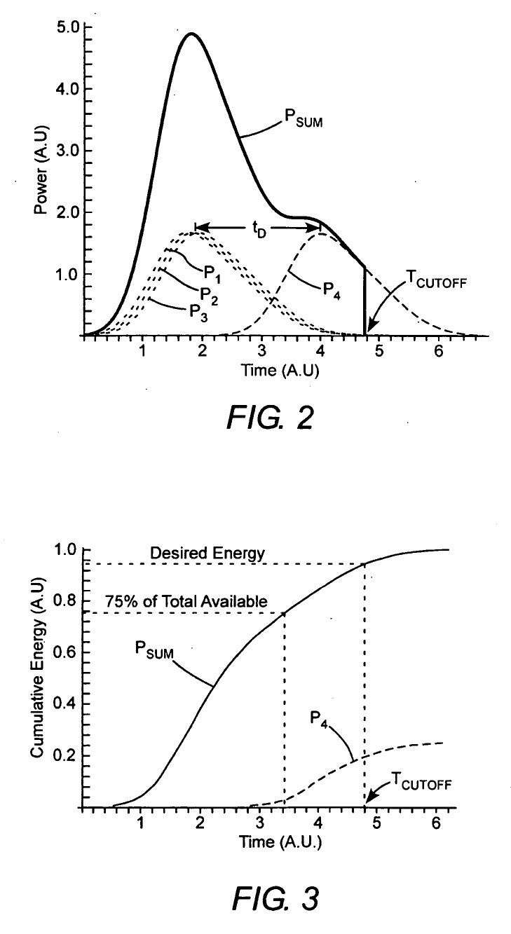

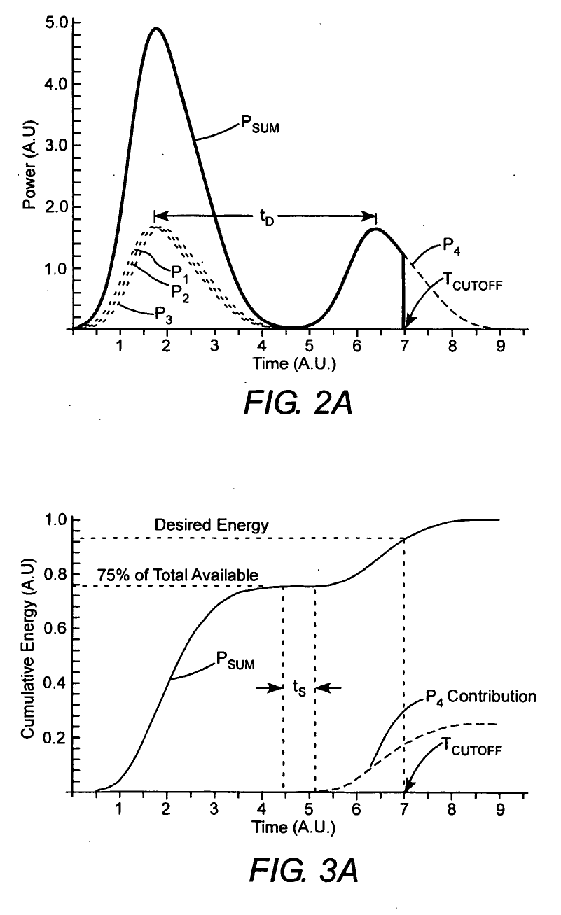

In order for this method of pulse control to be effective, certain conditions should be fulfilled. Energy per pulse in all lasers must be sufficiently repeatable and energy per pulse sufficient such that all N pulses together have at least the desired energy and preferably greater that the desired energy. Preferably N-1 pulses should not, under any foreseeable circumstance, supply greater than about the desired pulse energy. Delay time t_{D} for delivering the N^{th} or control pulse (here, the fourth) is preferably selected such that that pulse is not delivered until the other N-1 pulses have deposited most of the energy therein into the cumulative pulse. A discussion of the effect of delay time t_{D} on the pulses on the effectiveness of control is presented below beginning with reference to FIG. 2 and FIG. 3.

FIG. 2 schematically illustrates computed power as a function of time for a cumulative pulse P_{SUM} formed by delivering hypothetical pulses P₁, P₂, and P₃, (short-dashed curves) essentially simultaneously, and a pulse P₄ after a delay time t_{D}. Delivery of pulse P4 is depicted as being terminated at a time T_{CUTOFF} to provide a desired value of energy in pulse P_{SUM}. A relatively very short delay between pulses P₁, P₂, and P₃ is included here simply to allow the individual pulses to be depicted and is sufficiently short with respect to t_{D} that the shape of P_{SUM} is essentially the same as if pulses P₁, P₂, and P₃ were simultaneously delivered.

The pulses in the computation of FIG. 2 are assumed to be equal in peak power, temporal distribution, and duration. Delay time t_{D} here, is about equal to the duration of any one pulse at about the 30% peak power points. The temporal distribution of the pulses is represented by an equation arbitrarily selected, for purposes of computation, to be somewhat representative of Q-switched pulses. Such pulses have a skewed temporal distribution of power, characterized by a rising edge that is faster than the falling edge. In practice, there is no single equation to define a Q-switched pulse. The temporal distribution of such a pulse is dependent, inter alia, on the degree to which the gain-medium of the laser is pumped above a threshold value for lasing and on the decay time of the laser resonator.

FIG. 3 schematically illustrates computed cumulative power in combined pulse P_{SUM} together with the contribution to that cumulative power by pulse P₄. Here, when 75% of the total available energy in all four pulses has been delivered about 85% of the energy in pulse P₄ remains to be delivered. Accordingly, controlling the duration of this pulse can effectively control delivery of the total energy in the pulse. Delivery of pulse P4 is terminated at a point T_{CUTOFF} to control the total energy in the pulses to the desired value as discussed above.

FIG. 2A and FIG. 3A schematically illustrate a pulse sequence similar to the pulse sequence of FIG. 2 and FIG. 3, but wherein time t_{D} is selected such that all of the energy in pulses P₁, P₂, and P₃, has been delivered for a time ts (see FIG. 3A) before delivery of pulse P₄ is initiated. This sequence minimizes the possibility a control error due to residual energy delivery by pulses P₁, P₂, and P₃ while pulse P₄ is delivering energy. Clearly, any process for which the pulses were being used would not have to be adversely affected by the short discontinuity in energy delivery. In one sequence contemplated in an example of the apparatus of FIG. 1, three pulses of 150 ns duration are delivered in a period of 200 ns with the fourth pulse being delivered after 500 ns.

In certain applications, for example, in UV optical lithography, it is desirable to increase available pulse energy without significantly increasing pulse power. This is because the increased energy is useful for shortening exposure times and increasing throughput, while a significant increase in power could reduce the lifetime of imaging optics due to optical damage by the UV radiation.

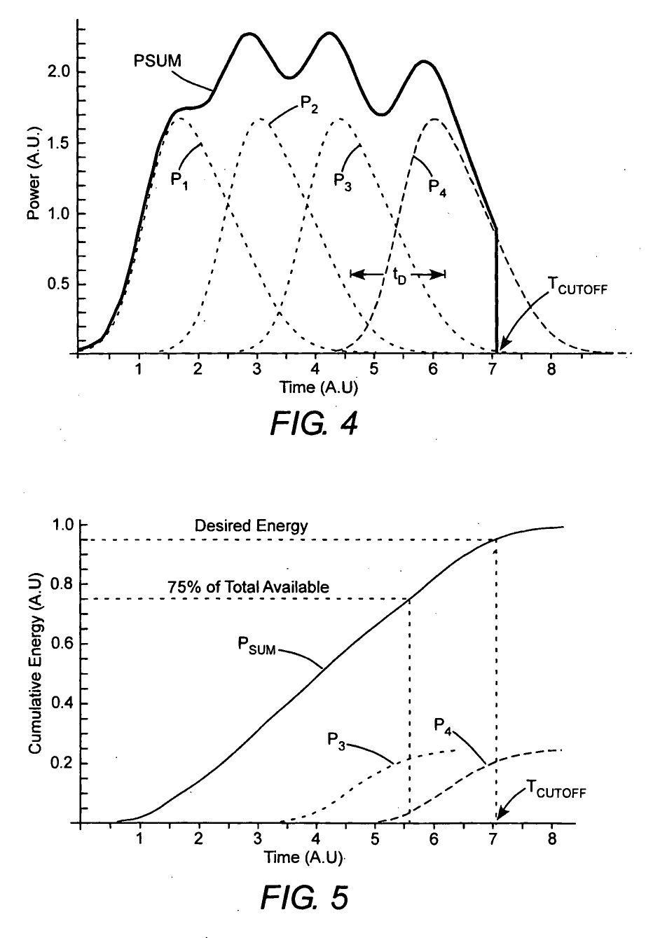

FIG. 4 schematically illustrates an example of pulse combination and control in accordance with the present invention wherein hypothetical pulses P₁, P₂, P₃ and P₄ are spaced apart in time to avoid a large increase in peak power while providing up to four times the energy of any one pulse. The drawing schematically illustrates computed power as a function of time for a cumulative pulse P_{SUM} formed by delivering hypothetical pulses P₁, P₂, and P₃, equally spaced in time and delivering pulse P₄ a delay time t_{D} after the delivery of pulse P₃. Again, delivery of pulse P4 is depicted as being terminated at a time T_{CUTOFF} to provide a desired value of energy in the pulse P_{SUM}. The pulse spacing is such that the peak power in P_{SUM} is only about 35% higher than the peak power of any individual pulse and such that the power in P_{SUM} does not fall below the individual pulse peak value between the rising edge and falling edge of P_{SUM}.

FIG. 5 schematically illustrates computed cumulative power in combined pulse P_{SUM} of FIG. 4, together with the contribution to that cumulative power of pulses P₃ and P₄. Here again, when 75% of the total available energy in all four pulses has been delivered about 85% of the energy in pulse P₄ remains to be delivered, and less than 10% of pulse P₃ remains to be delivered. Accordingly, controlling the duration of pulse P₄ can effectively control delivery of the total energy in the pulse. Delivery of pulse P₄ is indicated as being terminated at a point T_{CUTOFF} to control the total energy in the pulses to the desired value as discussed above with reference to FIGS. 2 and 3.

In either of the above-discussed examples of pulse combination it is possible that delay t_{D} can be selected such that that energy in pulses P₁, P₂ and P₃ is all delivered before delivery of pulse P₄ is initiated as discussed above with reference to FIGS. 2A and 3A. This would be useful in a situation where repeatability of pulse energy in the pulses was sufficiently poor that it was possible for pulses P₁, P₂ and P₃ to occasionally deliver all of the of the desired energy without a contribution for pulse P₄ being necessary. On such occasions, activation of the Pockels cell would prevent delivery of a fourth pulse, i.e., would terminate the pulse delivery of pulse P4 before it was initiated. Also, given such poor reproducibility, situations could occasionally occur in which energy delivered by pulses P₁, P₂ and P₃ were only just or less than sufficient to supply three quarters of the desired energy. In such situations, the entire energy of pulse P₄ would need to be delivered and termination of the pulse would occur naturally, by cavity decay, without any activation of Pockels cell 35. It is important also to bear in mind that when termination of delivery of pulse P₄ is mentioned it is the harmonic pulse that is referred to. When the state of Pockels cell 35 prevents delivery of a harmonic pulse P₄, fundamental energy will still be delivered from the oscillator and amplifier of laser 18, but will prevented by downstream elements from reaching a workpiece being treated by the combination of harmonic pulses.

An advantage of combining pulses from lasers that operate independently is that pulse-to-pulse variation in energy in an uncontrolled sum of the N pulses would be about 1/√N of the pulse-to-pulse variation in individual pulses. This somewhat relaxes the stability requirements for the individual lasers and maximizes consistency in satisfying the above discussed energy conditions for N and N-1 pulses, which are important in effective operation on the inventive combined pulse energy control method. Clearly, however, as the number of lasers is increased, the less will be the percentage in the controlling (Nth) pulse of the total available energy and the less effective controlling energy in that pulse may be in controlling the total energy.

In considering the effectiveness of the inventive method it is important to consider the effect of an inevitable delay from the time of triggering the Pockels cell controller to the time when delivery of a 3H-pulse by laser 18 is terminated. This delay is estimated at between about 6 and 7 nanoseconds. Accordingly, pulse P_{SUM} will always have slightly more than the desired energy value, absent any measure to compensate for the delay.

In certain instances, for example when pulses are of a sufficiently long duration, it may be possible to simply ignore the effect of the delay since only a relatively small proportion of the total pulse energy will be delivered during that delay time. Further, the percentage of excess energy that is delivered by an Nth pulse as a result of the delay in terminating the pulse will be between about one N^{th} and one (N-1)^{th} of the excess energy percentage of the desired energy; By way of example, in a pulse having a width of about 150 ns, as is the case in examples of lasers exemplified above, a 6 ns overshoot will result in, at most, about 5% more pulse energy being delivered by the control pulse than is desired. In apparatus delivering 4 pulses to be combined, this would translate to an error of between about 1.25% and 1.7%in the desired energy. Such an error, in most applications would be more than acceptable. If the cutoff time occurred in the latter half of the control pulse delivery time, as would be the case in most operations, the error would be less, as energy delivery is rapidly decreasing with time in this period.

It is possible to anticipate the overshoot effect of the delay by reducing the trigger value from DAC 47 below the actual desired energy level by some amount determined from, say, an average energy per nanosecond delivered by pulse P₄ times the anticipated delay in nanoseconds. Even though some of the time the actual pulse energy delivered during the delay will be more or less than this average value, this simple compensation will provide a significant reduction in any error that would otherwise occur as a result of the delay. Here again, whatever residual error there is will be reduced as a percentage of the desired energy by about the fractional contribution of the final pulse to the total available energy in all pulses. Accordingly, in an apparatus combining four 125 ns-pulses it is possible to reduce the total-energy-control error due to the reaction delay of the Pockels cell to less than 1%.

It is of course possible to compensate for the overshoot effect of the delay by including an optical delay line of appropriate length in the laser delivering the N^{th} or controlling pulse. This delay line must be included between the point at which the cumulative energy is sampled and the Pockels cell.

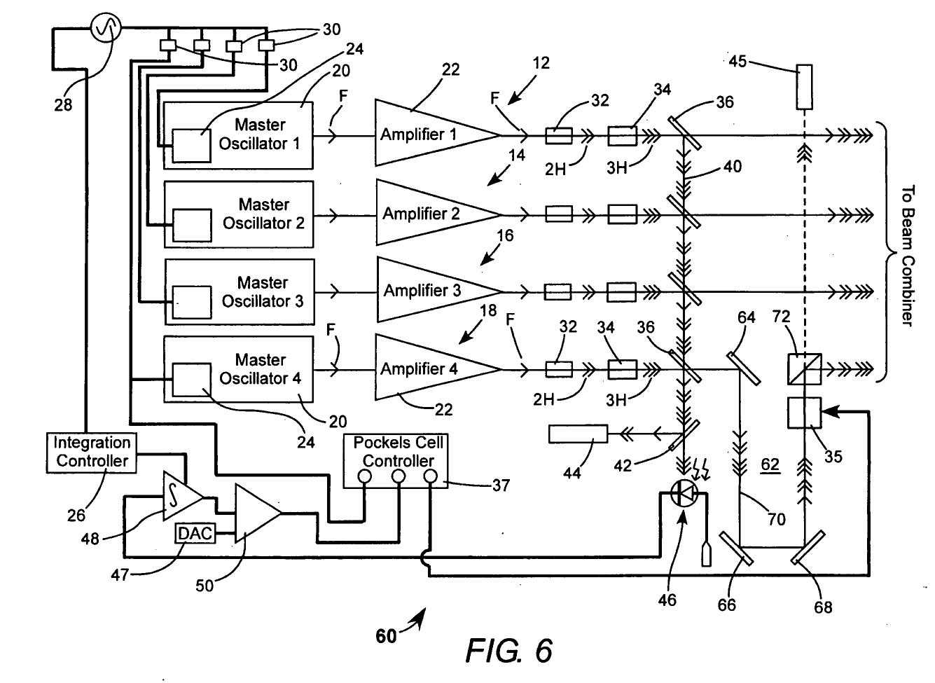

FIG. 6 schematically illustrates one embodiment 60 of apparatus in accordance with the present invention wherein such a delay line is included. Apparatus 60 is similar to apparatus 10 of FIG. 1 with exceptions as follows. Pockels cell 35 is removed from the position occupied in laser 10 wherein the cell is arranged to rotate the plane of polarization of fundamental radiation to stop generation of second and higher harmonic radiation. In apparatus 60, Pockels cell 35 is located in the path of 3H-output radiation from laser 18, here again, being the laser delivering the controlling pulse. An optical delay line 62 is located in the path of 3H-radiation delivered by the laser immediately following output-sampling mirror 36. Delay line 62 is formed by diverting output radiation from laser 18 via turning mirrors 64, 66, and 68 along an extended path 70 to Pockels cell 35.

Radiation transmitted by Pockels cell 35 is normally reflected by a polarization selective reflector 72 toward the beam combiner. Pockels controller cell 35 is activated, after the above-discussed reaction delay, when measured cumulative energy reaches a value representative of a desired total energy. Pockels cell 35 is arranged to rotate the polarization plane of the 3H-radiation on activation such that the 3H-radiation is now transmitted by polarization selective reflector 72, is not directed to the beam combiner, and accordingly, is not included in the combined pulse. The transmitted 3H radiation in this case is directed to a beam dump 45.

The time required for this system to divert the unwanted portion of the laser pulses is in a range between about 6 and 7 ns as discussed above. Accordingly, turning mirrors 64, 66, and 68, and Pockels cell 35 are positioned to provide a delay of radiation in path 70 of about this time. This corresponds to an increase in the 3H-radiation path length of about 2 meters. Preferably, the length of path 70 in delay line 62 is made adjustable for “fine tuning” apparatus 60. Alternatively, an adjustable delay circuit could be built into Pockels cell controller 37 so that an additional calibration element is provided for fine tuning the delay.

It should be noted here that this arrangement of the Pockels cell and polarization selective reflector is but one possible arrangement, selected, here, for convenience of illustration. Those skilled in the art will recognize that other arrangements providing switching of 3H-radiation out of a path toward the beam combiner are possible without departing from the spirit and scope of the present invention. By way of example, the Pockels cell and polarization selective reflector can be arranged such that the 3H-radiation is normally transmitted by the polarization selective reflector, with unwanted 3H-radiation being reflected out of a path to the beam combiner when the Pockels cell is activated.

It should also be noted that if the 3H-radiation switched by the arrangement of Pockels cell and polarization select is ultraviolet (UV) radiation having a relatively high power, for example, several Watts, problems may be experienced with optical degradation of the polarization selective reflector. These problems could result from UV degradation of substrate material and optical bonding material in the bi-prism of the illustrated example, or from UV degradation or spectral shift of thin film coatings in a bi-prism or a front-surface polarization-selective reflector. Regardless of wavelength, the extinction ratio of bi-prism type polarization selective reflectors can be significantly limited by stress birefringence, either residual in the bi-prism material, or induced by stresses resulting from manufacturing and bonding operations. This could result in some “un-switched” amount of the unwanted radiation being included in a combined pulse. A particular advantage of the pulse control arrangement of FIG. 1 is that by utilizing a harmonic generating crystal as the polarization selective device in combination with the Pockels cell, the polarization selective reflector of the conventional Pockels cell switch of FIG. 6 is not required, thereby avoiding any potential problems associated therewith.

In embodiments of the inventive apparatus described above with reference to FIGS. 1 and 6, switching operations for Pockels cell 35 are controlled primarily by analog electronic components. In cases, however, where pulse durations are sufficiently long, or when digital processor operations are sufficiently fast compared with pulse durations, a digital processing method is possible, which, by measuring the rate of accumulation of energy, can compute the time at which the control pulse should be terminated to deliver only the desired total energy. This method of course requires that the nominal temporal power distribution in individual pulses be known and stored for use in computation. The method is described briefly below with reference to the pulse combination scheme of FIGS. 4 and 5 for which the method is particularly suitable.

In the method of FIGS. 4 and 5, the duration of combined pulse P_{SUM} is between about three and four times the duration of an individual pulse. Over most of the duration of pulse, the energy accumulation rate is approximately linear. Accordingly, at a point where between about 60% and 70% of the total available energy in all four pulses has been delivered, it will be possible to compute, with reasonable probability, how much energy would be delivered if all of pulse P₄ were delivered, as this delivery begins in the linear portion of the P_{SUM} curve of FIG. 5. The desired energy can be subtracted from this computed total to determine how much energy must be delivered by pulse P₄ to provide the desired energy, and, accordingly, at what time (T_{CUTOFF}) pulse P₄ must be terminated. Design of processor and software architecture for implementing this method are within the capabilities of those skilled in the electronic art and accordingly such design is not discussed herein.

This “anticipation” method has an advantage that the contribution of any portion of pulse P₃ that occurs during delivery of control pulse P₄ is taken into account in the calculation. This allows a closer temporal spacing of the control pulse to a previous pulse than is possible in the analog method described above, thereby allowing more flexibility in determining power distribution in a combined pulse. The method also has an advantage that delays due to computation time and electronic reaction time of switching devices can be considered in calculating T_{CUTOFF}. The effectiveness of the method will of course be limited be any pulse-to-pulse variations from the assumed nominal in the temporal power distribution of control pulse P₄ in particular.

It should be noted here that while the present invention has been described with reference to four frequency-converted lasers including a master oscillator and a power amplifier, certain aspects of the invention are applicable to any frequency-converted laser with or without an amplifier. Other aspects of the invention are applicable to controlling the energy in a combination of pulses from a plurality of lasers whether or not the lasers include frequency conversion. Further, while the invention is described with reference to delivery of pulses from Q-switched lasers, the application is not limited to combining Q-switched pulses but may be applied to lasers delivering free running pulses such as would be obtained from pulsed lasers wherein pulsed operation is effected by pulsing pump energy delivered to the laser gain-medium. In general, while the present invention is described above in terms of a perferred and other embodiments, the invention is not limited to the embodiments described and depicted. Rather, the invention is limited only by the claims appended hereto.

What is claimed is:

1. A method for terminating generation of frequency-converted output in a frequency-converted laser wherein at least one optically nonlinear crystal is arranged to generate the frequency-converted output from radiation plane-polarized in a predetermined polarization plane:
rotating the polarization plane of the radiation entering the optically nonlinear crystal.

2. The method of claim 1, wherein the frequency-converted laser is arranged to deliver third-harmonic radiation by frequency converting plane-polarized fundamental radiation by generating second harmonic radiation from the fundamental radiation in a first optically nonlinear crystal and by generating the third harmonic radiation by mixing the second-harmonic radiation with fundamental radiation in a second optically nonlinear crystal.

3. The method of claim 2, wherein the polarization plane of the plane-polarized radiation is rotated before entering the first optically nonlinear crystal.

4. The method of claim 2, wherein the polarization plane of the second harmonic radiation is rotated before entering the second optically nonlinear crystal.

5. A method of controlling frequency-converted pulse energy in a frequency-converted pulsed laser wherein at least one optically nonlinear crystal is arranged to generate a pulse of frequency-converted radiation from a pulse of fundamental radiation delivered by the laser and being plane polarized in a predetermined polarization plane, comprising:
determining cumulative energy delivered by the frequency converted radiation pulse during delivery of the pulse; and
when the cumulative energy has been determined to have reached a predetermined value, rotating the polarization plane of the fundamental pulse radiation, thereby terminating generation of the frequency-converted pulse.

6. A method of generating a pulse of laser radiation having a predetermined pulse energy, comprising:
generating a plurality N of laser pulses from a corresponding plurality of lasers with delivery of a final (NPe) one of the pulses being initiated at a predetermined time after initiation of delivery of another one of the pulses; and
terminating delivery of the N^{th} laser pulse such that the total amount of energy in the delivered pulses is about the predetermined energy.

7. The method of claim 6, further including
selecting the number N and energy of pulses in said plurality thereof such that said N pulses have a total available energy greater than the predetermined energy and N-1 of said pulses have a total available energy less than the predetermined energy;
determining cumulative energy delivered by the laser pulses during delivery of the pulses; and
from said determination, initiating the N^{th} pulse delivery termination step.

8. A method of delivering an amount of laser radiation having a predetermined energy to a laser beam combiner, comprising:
delivering plurality N-1 of laser pulses from a corresponding plurality of N lasers to the beam combiner;
determining the cumulative energy delivered by the N-1 laser pulses; and
if the cumulative energy is determined to be less than the predetermined energy, delivering from an N^{th} laser a portion of an N^{th} pulse sufficient such that the total energy delivered is about equal to the predetermined energy.

9. A method of operating a laser system, said laser system including at least two lasers generating a pulsed output at a fundamental wavelength, the output from each laser being directed through an associated non-linear crystal to generate a higher harmonic output, said method comprising the steps of:
monitoring the energy of the higher harmonic output; and
changing the polarization state of the fundamental output from one of said lasers prior to entering the non-linear crystal when the monitored energy reaches a predetermined value in order to terminate the conversion of the fundamental wavelength output of said one laser into the higher harmonic output.

10. A method as recited in claim 9, wherein the output pulses of said one laser are delayed with respect to the pulses of any other laser.

11. A method as recited in claim 10, wherein the higher harmonic output pulses are combined to form a single longer pulse.

12. A laser system comprising:
a first laser generating a pulsed output at a fundamental wavelength, said output being directed through a first non-linear crystal to generate a higher harmonic output;
a second laser generating a pulsed output at a fundamental wavelength, said output being directed through a second non-linear crystal to generate a higher harmonic output;
a polarization modifier positioned to receive fundamental light generated by the second laser prior to reaching the second non-linear crystal;
a detector for monitoring the energy of the higher harmonic output generated by the non-linear crystals; and
a controller for controlling the operation of the lasers and the polarization rotator, and receiving data generated by said detector, said controller for causing said first laser to generate a pulse of light and thereafter causing the second laser to generate a pulse of light, and wherein said controller thereafter energizes said polarization modifier when the energy of the higher harmonic output monitored by the detector reaches a predetermined value in order to terminate the conversion of the fundamental wavelength output from said second laser into the higher harmonic output.

13. A laser system as recited in claim 12, further including a third laser generating a pulsed output at a fundamental wavelength, said output being directed through a third non-linear crystal to generate a higher harmonic output and wherein said controller operates to cause said third laser to generate a pulse of light prior to the pulse of light generated by the second laser.

14. A laser system as recited in claim 13, further including a means for combining the higher harmonic output pulses into a single longer pulse.
